(19) United States
(12) Patent Application Publication
(10) Pub. No.: US 2026/0233490 A1
(43) Pub. Date: Aug. 13, 2026

(54) WATER-IMPERMEABLE MULTI-LAYER ABSORBENT TOWEL

(71) Applicant: Cascada Luxe LLC, Kennesaw, GA (US)

(72) Inventor: Rachel Macharia, Kennesaw, GA (US)

(21) Appl. No.: 19/530,490

(22) Filed: Feb. 5, 2026

Related U.S. Application Data
(60) Provisional application No. 63/755,403, filed on Feb. 7, 2025.

(51) Int. Cl. B32B 5/02; B32B 5/24; B32B 38/00

(52) U.S. Cl. CPC B32B 5/024; B32B 5/026; B32B 5/24; B32B 38/0004; B32B 2250/03; B32B 2307/306; B32B 2307/714; B32B 2307/7265; B32B 2432/00; B32B 2555/00

(57) ABSTRACT

An impermeable towel apparatus comprises a first absorbent layer and a second absorbent layer with a water-impermeable barrier layer disposed therebetween. The barrier layer comprises materials such as thermoplastic polyurethane, silicone rubber, or polyvinyl chloride. The first and second absorbent layers are bonded to the barrier layer across substantially an entire surface area of the apparatus. The apparatus is configured to absorb liquids on both outer surfaces while preventing liquid penetration through the barrier layer. The absorbent layers may comprise cotton, terry cloth, or microfiber materials. The apparatus maintains flexibility and durability through repeated washing cycles at elevated temperatures. A method of manufacturing includes positioning the barrier layer between absorbent layers and bonding using heat welding, ultrasonic welding, adhesive bonding, or stitching. The bonding process may apply heat and pressure simultaneously at temperatures between 120°C and 180°C, creating a permanent laminated structure suitable for general toweling applications.

### RELATED APPLICATION

Under provisions of 35 U.S.C. §119(e), the Applicant claims benefit of U.S. Provisional Application No. 63/755,403 filed on February 7, 2025, and having inventors in common, which is incorporated herein by reference in its entirety.

It is intended that the referenced application may be applicable to the concepts and embodiments disclosed herein, even if such concepts and embodiments are disclosed in the referenced application(s) with different limitations and configurations and described using different examples and terminology.

### FIELD OF DISCLOSURE

The present disclosure generally relates to textile products. More specifically, the disclosure pertains to impermeable towels designed for multiple uses in personal care and household applications.

### BACKGROUND

In some situations, conventional towels may not provide adequate protection against liquid penetration. For example, when using a towel to protect furniture or bedding from spills, moisture may seep through the fabric and damage the underlying surface. Thus, the conventional strategy is to rely on the absorbent properties of traditional towels without addressing their limitations in liquid impermeability. This often causes problems because the conventional strategy does not fully prevent liquid from passing through the towel material. For example, a person using a standard towel as a barrier on a massage table may find that oils or lotions can still transfer onto the table surface, requiring additional cleanup and potentially damaging the equipment.

Conventional towels may be made from materials such as cotton, which can absorb a significant amount of liquid. However, these materials may not offer complete protection against moisture penetration. In some cases, users may attempt to layer multiple towels or combine them with plastic sheets to create a more effective barrier. This approach may be cumbersome and may not provide a reliable or convenient solution for various applications.

The limitations of conventional towels may become particularly apparent in scenarios where maintaining a dry surface is crucial. For instance, in medical settings, where preventing the spread of bodily fluids is essential for hygiene and safety reasons. Similarly, in outdoor activities such as beach outings or picnics, traditional towels may not effectively protect users from ground moisture or provide a completely dry seating area.

Furthermore, the absorbent nature of conventional towels may lead to prolonged drying times after use. This characteristic may be inconvenient in situations where quick drying and reuse are desired, such as in fitness centers or spa facilities. Additionally, the repeated washing and drying cycles required for frequently used towels may contribute to faster wear and tear, potentially reducing their lifespan and effectiveness over time.

In some situations, conventional towels may not provide adequate protection against liquid penetration. For example, when using a towel to protect furniture or bedding from spills, moisture may seep through the fabric and damage the underlying surface. Thus, the conventional strategy is to rely on the absorbent properties of traditional towels without addressing their limitations in liquid impermeability. This often causes problems because the conventional strategy does not fully prevent liquid from passing through the towel material. For example, a person using a standard towel as a barrier on a massage table may find that oils or lotions can still transfer onto the table surface, requiring additional cleanup and potentially damaging the equipment.

Conventional towels may be made from materials such as cotton, which can absorb a significant amount of liquid. However, these materials may not offer complete protection against moisture penetration. In some cases, users may attempt to layer multiple towels or combine them with plastic sheets to create a more effective barrier. This approach may be cumbersome and may not provide a reliable or convenient solution for various applications.

The limitations of conventional towels may become particularly apparent in scenarios where maintaining a dry surface is crucial. For instance, in medical settings, where preventing the spread of bodily fluids is essential for hygiene and safety reasons. Similarly, in outdoor activities such as beach outings or picnics, traditional towels may not effectively protect users from ground moisture or provide a completely dry seating area.

Furthermore, the absorbent nature of conventional towels may lead to prolonged drying times after use. This characteristic may be inconvenient in situations where quick drying and reuse are desired, such as in fitness centers or spa facilities. Additionally, the repeated washing and drying cycles required for frequently used towels may contribute to faster wear and tear, potentially reducing their lifespan and effectiveness over time.

In industrial settings, the inadequacy of conventional towels may pose challenges in containing spills or leaks of hazardous materials. The lack of a reliable barrier may increase the risk of workplace accidents and environmental contamination. Moreover, in food service environments, standard towels may not sufficiently prevent cross-contamination between surfaces, potentially compromising food safety standards.

The limitations of traditional towels may also extend to personal care applications. For instance, individuals with incontinence issues may find that conventional towels do not provide adequate protection against leaks, leading to discomfort and potential embarrassment. Similarly, in childcare settings, standard towels may not effectively contain diaper-related accidents, creating hygiene concerns and increasing the workload for caregivers.

In the realm of sports and fitness, the inability of conventional towels to provide a complete moisture barrier may impact performance and comfort. Athletes may struggle to maintain a dry grip on equipment or surfaces, potentially affecting their performance and safety. Additionally, in yoga or Pilates classes, standard towels may not effectively prevent sweat from seeping through to the mat, creating slippery and unhygienic conditions.

The shortcomings of traditional towels may also be evident in the hospitality industry. Hotels and resorts may face challenges in protecting mattresses and furniture from spills or bodily fluids, leading to increased maintenance costs and potential guest dissatisfaction. Furthermore, in spa settings, the lack of a reliable moisture barrier may result in the need for frequent linen changes and additional cleaning procedures.

Attempts to address these issues have resulted in various solutions, each with its own limitations. Waterproof covers or plastic sheets may provide a barrier against moisture but lack the absorbency and comfort of traditional towels. These materials may also be noisy, prone to tearing, and less environmentally friendly due to their non-biodegradable nature.

Disposable absorbent pads, often used in medical or childcare settings, may offer a temporary solution. However, their single-use nature may lead to increased waste and higher long-term costs. Additionally, these pads may not be suitable for all applications due to their limited size and absorbency capacity.

Some manufacturers have developed towels with water-resistant coatings. While these may offer improved protection compared to standard towels, the coatings may wear off over time, reducing their effectiveness. The water-resistant properties may also diminish the towel's absorbency, limiting its usefulness in certain scenarios.

Layered fabric solutions, combining absorbent and water-resistant materials, have been attempted. However, these may result in bulky products that are less convenient to use and store. The layers may also separate or shift during use or washing, compromising the product's integrity and effectiveness.

Microfiber towels, known for their quick-drying properties, have gained popularity in some applications. While they may offer improved absorption compared to traditional cotton towels, they may not provide complete protection against liquid penetration. Their synthetic composition may also make them less suitable for certain skin types or applications requiring natural materials.

These existing solutions may fall short in addressing the diverse needs across various industries and personal use cases. The inadequacies of current options may highlight the need for a more comprehensive approach to moisture management and protection in towel design.

The need for a comprehensive solution to address the limitations of conventional towels in providing adequate liquid protection across various settings has become increasingly apparent. Traditional towels, while effective in absorbing liquids, may not offer sufficient impermeability to prevent moisture penetration in scenarios where maintaining a completely dry surface is crucial. This gap in functionality may lead to potential issues in medical environments, outdoor activities, industrial settings, and personal care applications, where the consequences of liquid seepage can range from minor inconveniences to significant safety concerns. A solution that combines the absorbent properties of conventional towels with enhanced liquid impermeability may be necessary to meet the diverse needs of users across different industries and personal use cases.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter’s scope.

An impermeable towel apparatus may comprise a first outer layer of absorbent material. The apparatus may include a second outer layer of absorbent material. An inner layer may be disposed between the first outer layer and the second outer layer. The inner layer may comprise a water-impermeable material. The first outer layer and the second outer layer may be bonded to the inner layer across substantially an entire area of the towel.

The first outer layer and the second outer layer may comprise cotton. The inner layer may comprise a material selected from the group consisting of polyvinyl chloride (PVC) and latex. The impermeable towel apparatus may have a thickness substantially similar to a standard towel. The inner layer may be resistant to heat, allowing the impermeable towel apparatus to undergo machine washing, machine drying, and dry cleaning processes.

An impermeable towel system may comprise a multi-layer towel structure. The multi-layer towel structure may include a first absorbent layer. The structure may include a second absorbent layer. A water-impermeable layer may be disposed between the first absorbent layer and the second absorbent layer. The first absorbent layer and the second absorbent layer may be bonded to the water-impermeable layer across substantially an entire area of the multi-layer towel structure. The multi-layer towel structure may be configured to absorb liquids while preventing liquid penetration through the water-impermeable layer.

The first absorbent layer and the second absorbent layer may comprise terry cloth material. The water-impermeable layer may comprise a heat-resistant polymer. The multi-layer towel structure may have a thickness within 20% of a thickness of a standard single-layer towel. The multi-layer towel structure may be configured to withstand machine washing, machine drying, and dry cleaning processes without degradation of the water-impermeable layer. The system may include a plurality of reinforced edge portions along a perimeter of the multi-layer towel structure. The reinforced edge portions may be configured to prevent separation of the first absorbent layer, the second absorbent layer, and the water-impermeable layer.

An impermeable towel apparatus may comprise a first absorbent layer. The apparatus may include a second absorbent layer. A water-impermeable barrier layer may be disposed between the first absorbent layer and the second absorbent layer. The first absorbent layer and the second absorbent layer may be bonded to the water-impermeable barrier layer across substantially an entire surface area of the impermeable towel apparatus. The impermeable towel apparatus may be configured to absorb liquids on both outer surfaces while preventing liquid penetration through the water-impermeable barrier layer.

The first absorbent layer and the second absorbent layer may comprise a material selected from the group consisting of cotton, terry cloth, microfiber, and bamboo fiber. The water-impermeable barrier layer may comprise a material selected from the group consisting of polyvinyl chloride (PVC), latex, polyurethane, and silicone. The impermeable towel apparatus may have a total thickness between 2 mm and 10 mm. The water-impermeable barrier layer may be heat-resistant and chemical-resistant, allowing the impermeable towel apparatus to withstand machine washing, machine drying, and dry cleaning processes without degradation.

The apparatus may include a reinforced perimeter edge enclosing the first absorbent layer, the second absorbent layer, and the water-impermeable barrier layer. The reinforced perimeter edge may be configured to prevent delamination of the layers. The first absorbent layer and the second absorbent layer may have different textures, providing different functionalities on each side of the impermeable towel apparatus. The impermeable towel apparatus may be configured in a shape selected from the group consisting of rectangular, circular, and contoured to fit a specific surface.

The apparatus may include at least one attachment mechanism disposed along an edge of the impermeable towel apparatus. The attachment mechanism may be configured to secure the impermeable towel apparatus to an object or surface. The impermeable towel apparatus may be treated with at least one of an antimicrobial agent, an odor-resistant agent, and a stain-resistant agent.

The impermeable towel apparatus may be provided as part of a multi-component towel system. The first absorbent layer and the second absorbent layer may comprise terry cloth material. The water-impermeable layer may comprise a heat-resistant polymer. The multi-layer towel structure may have a thickness within 20% of a thickness of a standard single-layer towel. The multi-layer towel structure may be configured to withstand machine washing, machine drying, and dry cleaning processes without degradation of the water-impermeable layer. The system may include a plurality of reinforced edge portions along a perimeter of the multi-layer towel structure. The plurality of reinforced edge portions may be configured to prevent separation of the first absorbent layer, the second absorbent layer, and the water-impermeable layer.

A method of using an impermeable towel apparatus may comprise providing an impermeable towel apparatus comprising a first absorbent layer, a second absorbent layer, and a water-impermeable barrier layer disposed therebetween. The method may include contacting a liquid with a first surface of the first absorbent layer. The method may include absorbing the liquid into the first absorbent layer. The method may include preventing penetration of the liquid through the water-impermeable barrier layer to the second absorbent layer. The second absorbent layer may remain substantially dry during absorption by the first absorbent layer.

The method may include simultaneously contacting a second liquid with a second surface of the second absorbent layer. The method may include absorbing the second liquid into the second absorbent layer while maintaining separation between the first liquid and the second liquid via the water-impermeable barrier layer.

A method of manufacturing an impermeable towel apparatus may comprise providing a first absorbent layer and a second absorbent layer. The method may include positioning a water-impermeable barrier layer between the first absorbent layer and the second absorbent layer. The method may include bonding the first absorbent layer and the second absorbent layer to the water-impermeable barrier layer across substantially an entire surface area using a bonding process selected from the group consisting of heat welding, ultrasonic welding, adhesive bonding, and stitching. The method may include forming a reinforced perimeter edge to prevent delamination of the layers.

The bonding process may create a substantially uniform bond strength across the entire surface area of the impermeable towel apparatus. The bonding process may comprise applying heat and pressure simultaneously across the entire surface area at a temperature between 120°C and 180°C for a duration of 10 to 60 seconds, creating a permanent laminated structure that maintains flexibility and durability through repeated washing cycles.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates a water-impermeable multi-layer absorbent towel consistent with the present disclosure.

FIG. 2 is a cross-sectional view of the water-impermeable multi-layer absorbent towel of FIG. 1 along the line A-A.

FIG. 3 is a flowchart illustrating a method of using an impermeable towel apparatus.

FIG. 4 is a flowchart illustrating a method of manufacturing an impermeable towel apparatus.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely to provide a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such a term to mean based on the contextual use of the term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. §112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subject matter disclosed under the header.

The present disclosure addresses the technical problem of liquid penetration through conventional towels, which can lead to damage or discomfort in various scenarios. This issue may be particularly problematic in situations where protection of underlying surfaces is crucial, such as in healthcare settings, pet care environments, or when safeguarding furniture and bedding.

In one example, a nursing mother may use a conventional towel to protect her bed from breast milk leakage. However, the permeable nature of standard towels may allow moisture to seep through, potentially causing discomfort and staining of the bedsheets. The impermeable towel apparatus of the present disclosure may provide a solution to this problem by incorporating a water-impermeable layer between two absorbent layers.

Another scenario where the impermeable towel apparatus may prove beneficial is in pet care. When house training a puppy or caring for an elderly pet with incontinence issues, conventional towels placed on floors or furniture may not provide adequate protection against accidents. The liquid may penetrate through the towel, damaging the underlying surface. The impermeable towel apparatus may effectively contain the liquid within its absorbent layers while preventing it from reaching the protected surface.

In outdoor settings, such as at the beach or pool, users may face challenges with traditional towels that become saturated and allow water to seep through to blankets or beach chairs. The impermeable towel apparatus may address this issue by providing a barrier against moisture while still offering the absorbent properties expected of a towel.

Conventional protective solutions may present various limitations in practical applications. Plastic sheets may provide waterproof protection but lack absorption capability, potentially causing liquid pooling and user discomfort. Disposable pads may offer single-use absorption but generate waste and require frequent replacement, increasing long-term costs. Traditional towels may provide absorption but allow liquid penetration, potentially damaging underlying surfaces. The disclosed apparatus may address these limitations by combining absorption capability with barrier protection in a reusable configuration, potentially providing cost-effectiveness through repeated use while reducing environmental impact compared to disposable alternatives.

The impermeable towel apparatus may also find utility in healthcare settings. For instance, in a hospital or nursing home, where maintaining a hygienic environment is critical, the impermeable towel may be used to protect bedding or furniture from bodily fluids or spills. The water-impermeable layer may prevent cross-contamination and facilitate easier cleaning and maintenance of the surrounding area.

For medical and clinical applications, the apparatus may be configured with antimicrobial treatments in the absorbent layers and biocompatible barrier materials suitable for patient contact. Food service industry implementations may include food-grade materials and easy-clean surfaces for use in commercial kitchens and food preparation areas. Industrial spill containment versions may feature enhanced absorption capacity and chemical-resistant barrier layers for handling various industrial fluids. Automotive interior protection configurations may include custom sizing for vehicle seats and carpeting, with slip-resistant backing materials and compact folding capabilities for storage in vehicle compartments.

In each of these scenarios, the impermeable towel apparatus may offer a versatile solution that combines the familiar comfort and absorbency of a traditional towel with enhanced protective capabilities. By addressing the limitations of conventional towels, the present disclosure may provide a more effective and efficient means of managing liquid absorption and containment across a wide range of applications. Accordingly, while conventional towels are available in a variety of sizes and shapes, and for a variety of purposes, the liquid-impermeable towel apparatus may be desirable in similar sizes and shapes to address similar purposes. Accordingly, the liquid-impermeable towel apparatus should be widely available in similar shapes and sizes to traditional towels, as a feasible alternative in these contexts.

The impermeable towel apparatus may provide a solution that combines absorbency with enhanced protective capabilities. The apparatus may include a first outer layer, an inner layer, and a second outer layer. The inner layer may be disposed between the first outer layer and the second outer layer.

The first outer layer and the second outer layer may comprise absorbent materials. These absorbent materials may include cotton, terry cloth, microfiber, bamboo fiber, or other suitable absorbent fabrics. The inner layer may comprise a water-impermeable material such as polyvinyl chloride (PVC), latex, polyurethane, silicone, and/or the like.

The first outer layer and the second outer layer may each be bonded to the inner layer across substantially the entire area of the towel apparatus. This bonding may prevent separation or slippage of the layers during use or washing.

The impermeable towel apparatus may have a thickness that is substantially similar to a standard towel. For example, the total thickness of the apparatus may be between 2 mm and 10 mm. This thickness may allow the apparatus to be used and stored in a manner similar to conventional towels.

The inner layer may be resistant to heat, allowing the impermeable towel apparatus to undergo machine washing, machine drying, and/or dry cleaning processes without substantial degradation. This heat resistance may ensure the longevity and durability of the apparatus under normal use conditions.

The ability of the inner layer to withstand high temperatures may contribute to the overall durability and longevity of the impermeable towel apparatus. This heat resistance may allow the towel to undergo hundreds of wash and dry cycles without compromising its performance or water-barrier properties.

The impermeable towel apparatus may be configured in various shapes to suit different applications. These shapes may include square, rectangular, circular, and/or contoured designs to fit specific surfaces. The apparatus may also be produced in different sizes to accommodate various uses, such as personal towels, furniture covers, or bedding protectors.

In some embodiments, the impermeable towel apparatus may include reinforced edge portions along its perimeter. These reinforced edge portions may be configured to prevent separation of the first outer layer, the second outer layer, and the inner layer. The reinforced edges may also enhance the overall durability of the apparatus.

The impermeable towel apparatus may be treated with additional agents to enhance its functionality. These treatments may include antimicrobial agents, odor-resistant agents, and/or stain-resistant agents. Such treatments may extend the usability of the apparatus in various environments and applications.

The impermeable towel apparatus may offer several technical advantages over conventional towels. The water-impermeable inner layer may provide superior protection against liquid penetration compared to standard absorbent towels. This feature may be particularly beneficial in scenarios where preventing moisture transfer to underlying surfaces is critical, such as in healthcare settings or for protecting furniture.

The bonding of the first outer layer and second outer layer to the inner layer across substantially the entire area of the towel may enhance the overall structural integrity of the apparatus. This construction may prevent separation or shifting of the layers during use or washing, potentially extending the lifespan of the product.

The heat-resistant properties of the inner layer may allow the impermeable towel apparatus to withstand machine washing, drying, and dry cleaning processes without degradation. This durability may provide a significant advantage over conventional waterproof products that may not be suitable for regular machine washing.

The thickness of the impermeable towel apparatus, which may be similar to that of standard towels, may offer improved user comfort and ease of use compared to bulkier waterproof alternatives. This feature may also facilitate storage and transportation of the apparatus.

The versatility of the impermeable towel apparatus may be enhanced by its ability to absorb liquids on both outer surfaces while maintaining its impermeability. This dual-sided functionality may increase the range of potential applications for the product.

The dual-surface absorption capability may be achieved through specific design parameters that enable independent liquid management on each side. Each absorbent layer may have sufficient thickness and porosity to contain absorbed liquids without reaching saturation levels that would cause liquid migration toward the barrier layer. The absorption capacity may be designed such that each layer can absorb 150-300% of its dry weight in liquid while maintaining at least 2 mm distance between the wetted region and the barrier interface. Capillary action within each absorbent layer may be controlled through fiber orientation and density, creating preferential liquid flow parallel to the barrier surface rather than perpendicular penetration. The barrier layer impermeability may be verified through hydrostatic pressure testing at 10 kPa for 24 hours with no detectable liquid transmission, ensuring complete separation between the two absorbent regions during simultaneous use.

The reinforced edge portions may provide additional durability to the impermeable towel apparatus by helping to prevent delamination and enhancing overall product longevity. This feature may be particularly beneficial in high-stress applications or frequent use scenarios.

The availability of the impermeable towel apparatus in various shapes and sizes may allow for customized solutions across different applications, potentially improving its effectiveness in specific use cases compared to standard, uniformly-shaped towels.

The potential inclusion of additional treatments, such as antimicrobial, odor-resistant, or stain-resistant agents, may further enhance the functionality of the impermeable towel apparatus. These treatments may provide added value in environments where hygiene and cleanliness are paramount.

The different textures that may be present on the first outer layer and second outer layer may offer users the ability to choose the most appropriate surface for their specific needs, improving the overall user experience and effectiveness of the product.

The optional attachment mechanism may provide additional versatility by allowing the impermeable towel apparatus to be secured to objects or surfaces. This feature may be particularly advantageous in outdoor or high-movement scenarios where stability is crucial.

The present disclosure includes many aspects and features. Moreover, while many aspects and features relate to, and are described in, the context of an impermeable towel apparatus, embodiments of the present disclosure are not limited to use only in this context.

### I. Platform Overview

This overview is provided to introduce a selection of concepts in a simplified form that are further described below. This overview is not intended to identify key features or essential features of the claimed subject matter. Nor is this overview intended to be used to limit the claimed subject matter’s scope.

The impermeable towel apparatus of the present disclosure may provide a versatile solution for absorbing liquids while preventing moisture penetration. This apparatus may combine the familiar comfort and absorbency of a traditional towel with enhanced protective capabilities.

The impermeable towel apparatus may comprise three main layers: a first outer layer, an inner layer, and a second outer layer. The first outer layer and the second outer layer may be composed of absorbent materials such as cotton, terry cloth, microfiber, or bamboo fiber. These absorbent layers may provide the familiar feel and functionality of a standard towel.

The inner layer may be disposed between the first outer layer and the second outer layer. This inner layer may be composed of a water-impermeable material such as polyvinyl chloride (PVC), latex, polyurethane, or silicone. The water-impermeable inner layer may act as a barrier to prevent liquid from penetrating through the entire thickness of the towel.

The impermeable towel apparatus may include bonding of both the first outer layer and the second outer layer to the inner layer. This bonding may occur across substantially the entire area of the towel apparatus. Such comprehensive bonding may help prevent separation or slippage of the layers during use or washing.

The bonding across substantially the entire area may be achieved through various specific techniques that ensure uniform adhesion. As non-limiting examples, for heat welding applications, the bonding may cover at least 85% of the total surface area, with unbonded regions not exceeding 2 cm in any dimension. The bonding pattern may include a grid of bonded areas spaced no more than 5 cm apart, or continuous bonding lines with spacing not exceeding 3 cm between parallel lines. For ultrasonic welding, the bonding points may be distributed in a hexagonal pattern with point spacing between 8-15 mm, creating effective liquid barrier properties while maintaining flexibility. The bonding strength may be verified through peel testing, requiring a minimum force of 8 N/cm to separate the layers at any bonded location.

The overall thickness of the impermeable towel apparatus may be designed to be similar to that of a standard towel. For example, the total thickness may range between 2 mm and 10 mm. This thickness consideration may allow the apparatus to be used and stored in a manner similar to conventional towels, enhancing its practicality and user-friendliness.

The thickness control may be achieved through specific layer selection and compression techniques. Each absorbent layer may have an uncompressed thickness between 2-4 mm, while the water-impermeable barrier layer may contribute 0.2-0.8 mm to the total thickness. During bonding, controlled compression may reduce the total thickness by 15-25% compared to the sum of individual layer thicknesses. Standard terry cloth towels typically measure 4-7 mm in thickness, and the apparatus may be designed to fall within this range through material selection and processing parameters. Thickness uniformity may be maintained (e.g., within ±0.5 mm) across the entire surface area through precision roller systems during manufacturing.

The inner layer of the impermeable towel apparatus may be engineered to be resistant to heat. This heat resistance may allow the apparatus to undergo machine washing, machine drying, and dry cleaning processes without substantial degradation. Such durability may ensure the longevity of the apparatus under normal use conditions.

The heat resistance may be quantified through specific testing protocols and material specifications. The water-impermeable barrier layer may maintain structural integrity and impermeability when exposed to temperatures up to 90°C for washing cycles and up to 80°C for drying cycles for periods up to 2 hours. Heat resistance testing may be performed according to ASTM D1693 or equivalent standards, with samples showing no cracking, delamination, or loss of barrier properties after 50 thermal cycles between 20°C and 80°C. The barrier materials may have glass transition temperatures above 100°C and melting points above 150°C to ensure stability during standard laundering processes. Chemical resistance may be verified through exposure to standard laundry detergents at pH levels between 7-11 without degradation of barrier properties.

The impermeable towel apparatus may be configured in various shapes to suit different applications. These shapes may include square, rectangular, circular, or contoured designs to fit specific surfaces. The apparatus may also be produced in different sizes to accommodate various uses, such as personal towels, furniture covers or bedding protectors.

In some embodiments, the impermeable towel apparatus may include reinforced edge portions along its perimeter. These reinforced edge portions may be configured to prevent separation of the first outer layer, the second outer layer, and the inner layer. The reinforced edges may also enhance the overall durability of the apparatus.

The impermeable towel apparatus may be treated with additional agents to enhance its functionality. These treatments may include antimicrobial agents, odor-resistant agents, or stain-resistant agents. Such treatments may extend the usability of the apparatus in various environments and applications. For example, the impermeable towel apparatus may incorporate various antimicrobial and odor-resistant agents to enhance its functionality and hygiene properties. These agents may be applied to the outer absorbent layers, the inner impermeable layer, or both.

Medical and clinical configurations may incorporate specific material treatments and certifications to ensure patient safety and regulatory compliance. Antimicrobial treatments may utilize silver ion technology with concentrations of 50-200 ppm embedded in the absorbent fibers, providing log 3-4 reduction in bacterial counts according to AATCC 100 testing protocols. Biocompatible barrier materials may meet USP Class VI requirements for biological reactivity, with cytotoxicity testing demonstrating no adverse cellular response after 24-hour exposure. The apparatus may be manufactured in controlled environments meeting ISO 13485 standards, with materials traceable to medical-grade suppliers. Sterilization compatibility may be verified through gamma radiation exposure up to 25 kGy or ethylene oxide treatment cycles without degradation of barrier properties or antimicrobial effectiveness. Clinical versions may feature color-coding systems for different applications and lot numbering for traceability in healthcare settings.

Food service industry implementations may utilize materials and construction methods that meet commercial kitchen requirements and food safety regulations. Food-grade barrier materials may comply with FDA 21 CFR 177 regulations for food contact surfaces, with migration testing demonstrating no transfer of harmful substances under simulated use conditions at temperatures up to 100°C. The absorbent layers may incorporate materials approved for direct food contact, with resistance to common food acids (pH 3-4) and oils without degradation or odor absorption. Easy-clean surfaces may feature smooth, non-porous finishes that can be sanitized using commercial cleaning solutions with concentrations up to 200 ppm chlorine without material degradation. The apparatus may withstand commercial dishwasher cycles at 82°C with high-alkalinity detergents, maintaining structural integrity and barrier properties through 500 commercial wash cycles. Slip-resistant backing materials may provide coefficient of friction values exceeding 0.6 on wet stainless steel surfaces to prevent movement during use.

One type of antimicrobial agent that may be used is silver nanoparticles. These nanoparticles may be incorporated into the fibers of the outer absorbent layers during the manufacturing process. The silver nanoparticles may provide broad-spectrum antimicrobial activity against bacteria, fungi, and certain viruses.

Another potential antimicrobial treatment may involve the application of quaternary ammonium compounds to the towel surfaces. These compounds may be sprayed or padded onto the fabric and may provide long-lasting antimicrobial protection.

For odor resistance, activated carbon particles may be integrated into the towel structure. These particles may be mixed into the fibers of the outer layers or applied as a coating. The activated carbon may absorb odor-causing molecules, helping to keep the towel fresh between washes.

Zinc pyrithione may also be used as an antimicrobial and/or odor-resistant agent. This compound may be applied to the towel as a solution during the finishing process. Zinc pyrithione may inhibit the growth of odor-causing bacteria and fungi.

The application methods for these treatments may vary depending on the specific agent and desired outcome. For silver nanoparticles, the particles may be mixed directly into the fiber material before extrusion, ensuring even distribution throughout the fabric. Quaternary ammonium compounds may be applied using a spray or padding method, where the towel passes through a bath of the solution and is then dried and cured.

Activated carbon particles may be incorporated into the towel structure through several methods. They may be mixed into the fiber material before spinning, or they may be applied as a coating to the finished fabric. For coating applications, a binder may be used to ensure the particles adhere securely to the towel surface.

Zinc pyrithione may be applied using a padding method similar to that used for quaternary ammonium compounds. The towel may be passed through a bath containing the zinc pyrithione solution, then squeezed between rollers to remove excess liquid before being dried and cured.

These antimicrobial and/or odor-resistant treatments may be applied to the towel either individually or in combination, depending on the desired properties and performance characteristics. The specific combination and application methods help to ensure efficacy while maintaining the towel's absorbency, softness, and overall functionality.

The versatility of the impermeable towel apparatus may be further enhanced by its ability to absorb liquids on both outer surfaces while maintaining its impermeability. This dual-sided functionality may increase the range of potential applications for the product.

In some embodiments, the first outer layer and second outer layer may have different textures. This feature may provide users with the ability to choose the most appropriate surface for their specific needs, potentially improving the overall user experience and effectiveness of the product.

An optional attachment mechanism may be included in some versions of the impermeable towel apparatus. This mechanism may be disposed along an edge of the apparatus and may be configured to secure the towel to objects or surfaces. Such a feature may be particularly advantageous in outdoor or high-movement scenarios where stability is crucial.

The impermeable towel apparatus may offer several technical advantages over conventional towels. The water-impermeable inner layer may provide superior protection against liquid penetration compared to standard absorbent towels. This feature may be particularly beneficial in scenarios where preventing moisture transfer to underlying surfaces is critical, such as in healthcare settings or for protecting furniture.

Embodiments of the present disclosure may include components comprising, but not limited to, the following:

### A. Outer Layers

### B. An Inner Layer

### C. Reinforced Edge Portions

In some embodiments, the present disclosure may provide additional components, which may comprise, but need not be limited to:

### D. An Attachment Mechanism

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

### II. Platform Configuration

The impermeable towel apparatus may be utilized in various operating environments to provide enhanced liquid absorption and surface protection capabilities. In bathroom settings, the apparatus may be employed for drying after showers or baths, offering superior moisture management compared to conventional towels. The water-impermeable inner layer may prevent any residual moisture from penetrating through to underlying surfaces.

In living room environments, the impermeable towel apparatus may be strategically placed on furniture such as sofas or chairs to protect against spills, pet accidents, or other liquid-based messes. The absorbent outer layers may quickly capture any liquids, while the impermeable barrier may prevent moisture from seeping into upholstery or cushions.

For bedroom applications, the apparatus may serve as a protective layer on mattresses or bedding. It may be particularly useful for individuals prone to night sweats, for children during potty training, or for adults requiring incontinence protection. The impermeable towel may absorb moisture from the body while simultaneously shielding the mattress from liquid penetration.

In outdoor settings, the impermeable towel apparatus may function as a versatile beach or pool accessory. The absorbent outer layers may provide comfortable drying capabilities, while the water-resistant inner layer may create a barrier between the user and potentially damp or sandy surfaces. Additionally, the apparatus may offer protection from light rain or mist during outdoor activities.

Healthcare environments may benefit from the impermeable towel apparatus in various scenarios. For nursing mothers, the towel may be used to absorb and contain breast milk leakage while preventing moisture from spreading to clothing or furniture. In clinical settings, the apparatus may serve as a protective barrier during examinations or procedures where liquid containment is crucial.

Pet care situations may also utilize the impermeable towel apparatus effectively. During house training periods for puppies or kittens, the towel may be placed in designated areas to absorb accidents while protecting flooring underneath. The apparatus may also be used for grooming or bathing pets, containing excess water and preventing it from spreading to surrounding surfaces.

The impermeable towel apparatus may be adapted for use in automotive environments as well. It may be employed as a seat cover to protect vehicle upholstery from moisture, spills, or pet-related messes during transportation. The apparatus may also serve as a protective layer in the cargo area of vehicles when transporting potentially leaky items.

In industrial or workshop settings, the impermeable towel apparatus may be utilized for containing spills or leaks from machinery or equipment. The absorbent outer layers may quickly capture liquids, while the impermeable barrier may prevent seepage into sensitive areas or equipment.

Industrial spill containment configurations may incorporate enhanced materials and construction methods to handle various industrial fluids and demanding operating conditions. Chemical-resistant barrier layers may utilize fluoropolymer materials or chemically-resistant TPU formulations that demonstrate compatibility with common industrial chemicals including hydrocarbons, acids (pH 1-3), bases (pH 11-13), and organic solvents according to ASTM D543 testing protocols. Enhanced absorption capacity may be achieved through high-loft absorbent materials with absorption rates exceeding 800% of fabric weight for hydrocarbon liquids and 400% for aqueous solutions. The apparatus may feature reinforced construction with additional stitching or bonding along high-stress areas, capable of withstanding handling forces up to 200 N without structural failure. Temperature resistance may be extended to handle industrial process temperatures from -20°C to 120°C, with barrier integrity maintained throughout the extended temperature range. Industrial versions may include identification markings for chemical compatibility and disposal requirements, with materials selected for compatibility with standard industrial waste treatment processes.

For each of these operating environments, the impermeable towel apparatus may be manufactured in various sizes, shapes, and configurations to best suit the specific application. The materials used for the absorbent outer layers and the water-impermeable inner layer may be selected to optimize performance in each particular setting, while maintaining the overall structural integrity and functionality of the apparatus.

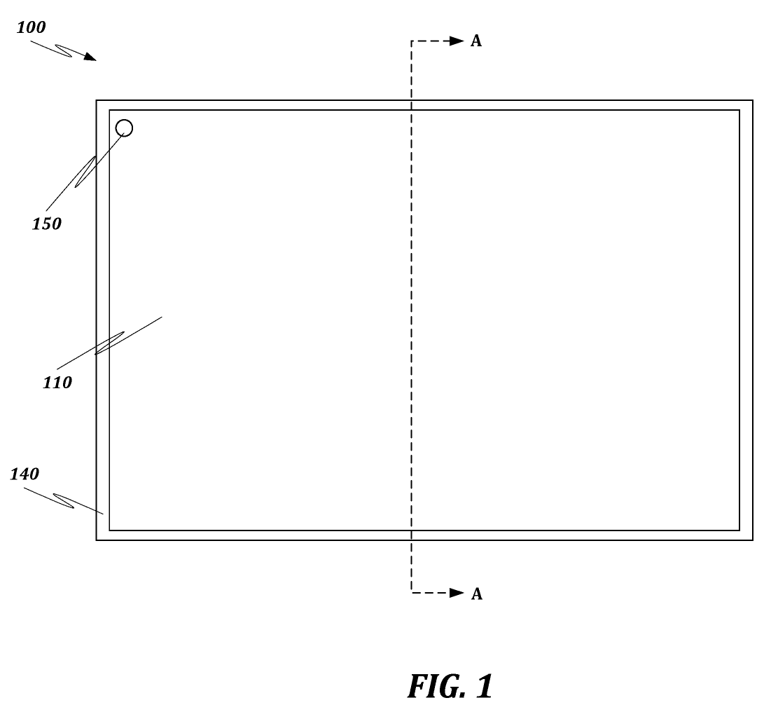

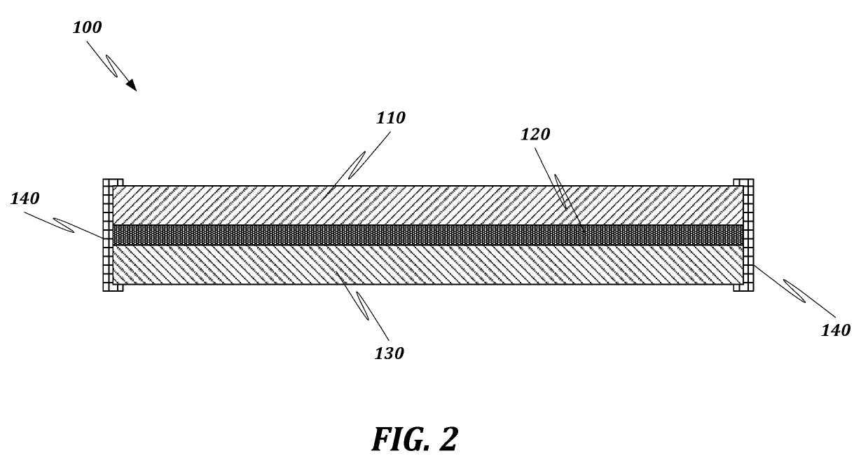

With reference to FIGS. 1 and 2, the operating environment for enabling embodiments of the present disclosure may include various settings where liquid absorption and surface protection are desired. The impermeable towel apparatus 100 may be utilized in residential, commercial, healthcare, and/or outdoor environments.

In a residential setting, the impermeable towel apparatus 100 may be employed in bathrooms, bedrooms, and living areas. In bathrooms, the apparatus 100 may be used for drying after showers or baths, with the first outer layer 110 providing absorbency while the inner layer 120 prevents moisture from penetrating to underlying surfaces. In bedrooms, the apparatus 100 may serve as protective bedding, with the second outer layer 130 in contact with the mattress or sheets, offering a barrier against spills or accidents.

The impermeable towel apparatus 100 may also find application in living areas, where it may be placed on furniture such as sofas or chairs. The first outer layer 110 may absorb spills or pet accidents, while the inner layer 120 prevents liquid from reaching the furniture upholstery. The second outer layer 130 may provide a comfortable surface against the furniture.

In commercial settings, such as hotels or spas, the impermeable towel apparatus 100 may be used as a versatile protective covering for massage tables, lounge chairs, or other surfaces where moisture control is desired. The apparatus 100 may be easily cleaned and reused, with its durable construction withstanding frequent washing and drying cycles.

Healthcare environments may benefit from the impermeable towel apparatus 100 in various ways. For nursing mothers, the apparatus 100 may be used to protect clothing from breast milk leakage. In hospitals or clinics, it may serve as a protective barrier on examination tables or patient beds, with the inner layer 120 preventing fluid transmission between the first outer layer 110 and the second outer layer 130.

Outdoor applications for the impermeable towel apparatus 100 may include use at beaches, pools, or during rainy conditions. When placed on sand or grass, the second outer layer 130 may contact the ground while the inner layer 120 prevents moisture from seeping through to the user sitting or lying on the first outer layer 110. In rainy conditions, the apparatus 100 may be draped over outdoor furniture or used as a temporary shelter, with the inner layer 120 providing water resistance.

The impermeable towel apparatus 100 may also be employed in pet care scenarios. During house training or for incontinent pets, the apparatus 100 may be placed on floors or furniture, with the first outer layer 110 absorbing accidents while the inner layer 120 protects the underlying surface.

The impermeable towel apparatus may be configured for various specialized applications. In some embodiments, the apparatus may be positioned between bed sheets and mattresses to provide menstruation protection, preventing liquid penetration while maintaining comfort and breathability. The apparatus may also be used during adult intimacy activities to protect bedding and furniture surfaces while providing absorbent coverage on both sides. For seasonal applications, the apparatus may serve as a window or door seal during winter months, with the absorbent layers managing condensation while the barrier layer prevents drafts. Additionally, the apparatus may function as a rain cover during swimming activities, providing protection from precipitation while absorbing moisture from wet swimwear.

In each of these operating environments, the impermeable towel apparatus 100 may provide a combination of absorbency and protection not typically found in conventional towels. The versatility of the apparatus 100 may allow it to be adapted to various situations where liquid management and surface protection are desired.

The impermeable towel apparatus 100 may include additional hardware components to enhance its functionality and versatility. One or more optional attachment mechanisms 150 may be incorporated along one or more edges of the apparatus 100. This attachment mechanism 150 may comprise hook-and-loop fasteners, snaps, buttons, ties, or other suitable fastening elements. The attachment mechanism 150 may allow the apparatus 100 to be securely fastened to furniture, bedding, and/or other surfaces as needed.

The impermeable towel apparatus may exhibit specific performance characteristics that can be quantitatively measured. The absorption capacity may range from 200-500 milliliters per square meter for each absorbent layer, depending on the material composition and thickness. Liquid penetration resistance may be tested according to ASTM standards, with the barrier layer preventing penetration under pressures up to 10 PSI for extended periods. Durability testing may demonstrate functionality retention through at least 100 wash and dry cycles at temperatures up to 60°C. Temperature resistance specifications may include barrier layer integrity maintenance from -20°C to 80°C, ensuring performance across various environmental conditions and laundering requirements.

Performance degradation indicators may provide quantitative criteria for determining when apparatus replacement is necessary to maintain intended functionality. Absorption capacity degradation may be identified when either absorbent layer fails to achieve 80% of original absorption capacity, measured through standardized testing with 100 ml water per 100 cm² surface area. Barrier integrity compromise may be detected through visual inspection for pinhole defects larger than 0.5 mm diameter, or through functional testing showing any detectable liquid penetration under 5 kPa pressure for 5 minutes. Bond strength degradation may be indicated by visible delamination at edges or corners, or measured bond strength values below 4 N/cm in T-peel testing. Flexibility loss may be identified through increased stiffness, measured as bending modulus increases exceeding 50% of original values, or visible cracking of the barrier layer during normal folding operations. Service life indicators may include cumulative wash cycle counts exceeding 150 cycles, or calendar age exceeding 2 years under normal use conditions, at which point performance verification testing should be conducted to determine continued suitability for intended applications.

Quality control testing procedures may ensure consistent performance and reliability across production batches. Statistical sampling may follow AQL 2.5 standards with sample sizes determined by lot size, typically testing 1-3% of production units for critical parameters. Barrier integrity testing may utilize hydrostatic pressure testing at 15 kPa for 10 minutes with zero penetration acceptance criteria, performed on 100% of production units using automated testing equipment. Bond strength verification may sample every 50th unit with T-peel testing requiring minimum 5 N/cm values across five test locations per unit. Absorption capacity testing may verify each absorbent layer achieves minimum 250% weight absorption within 30 seconds using distilled water at 23°C ± 2°C. Dimensional accuracy may be verified through coordinate measuring systems with tolerances of ±2 mm for critical dimensions. Environmental testing may include temperature cycling from -10°C to 70°C for 10 cycles to verify thermal stability, and UV exposure testing equivalent to 6 months outdoor exposure to assess material degradation resistance.

The flexibility and durability characteristics may be quantified through standardized testing protocols that demonstrate long-term performance. Flexibility may be measured through bend testing according to ASTM D2176, with the apparatus maintaining barrier integrity through 1000 cycles of 180-degree folding at room temperature. Durability testing may include accelerated aging protocols simulating 2 years of normal use through 200 wash/dry cycles at maximum recommended temperatures. Tensile strength testing may demonstrate that bonded assemblies maintain at least 80% of initial bond strength after durability testing. Flexibility retention may be verified through modulus testing, with the apparatus showing less than 25% increase in bending modulus after aging. The laminated structure may demonstrate resistance to delamination under normal handling forces up to 50 N applied perpendicular to the surface, ensuring structural integrity during typical toweling applications.

The liquid penetration prevention may be quantified through standardized testing protocols that demonstrate barrier effectiveness. Water penetration resistance may be measured using AATCC Test Method 127, with the barrier layer showing zero penetration under 13.8 kPa pressure for 5 minutes. For oil-based liquids, penetration resistance may be tested according to ASTM F903, demonstrating no breakthrough for common household liquids including cooking oils, lotions, and cleaning solutions. The barrier integrity may be maintained across temperature ranges from 5°C to 80°C, with penetration testing performed at temperature extremes to verify performance under various use conditions. Barrier effectiveness may be verified through dye penetration tests using methylene blue solution, with no color transfer detectable after 24-hour contact under 1 kPa pressure.

The apparatus may be designed with user experience considerations that enhance practical usability. The tactile feel may closely approximate conventional terry cloth towels through careful selection of outer layer materials and textures. Folding characteristics may be optimized through strategic placement of bonding patterns that create natural fold lines while maintaining structural integrity. Weight considerations may balance absorption capacity with portability, typically ranging from 200-800 grams depending on size and material selection. Grip and handling features may include textured edges or corner tabs that facilitate manipulation when wet, and the overall thickness may be maintained between 3-8 millimeters to provide familiar handling characteristics while accommodating the barrier layer.

User interface and ergonomic features may be optimized through specific design parameters that enhance practical usability and user acceptance. Tactile feel approximation to conventional terry cloth may be achieved through surface texture replication with loop pile heights matching standard terry cloth at 4-6 mm and loop density of 200-250 loops per square inch. Weight distribution may be optimized to achieve 300-600 g/m² depending on size, providing familiar handling characteristics while accommodating the barrier layer. Grip enhancement features may include textured corner tabs measuring 5 cm × 5 cm with raised patterns providing 0.5 mm surface relief for improved handling when wet. Folding characteristics may be engineered through strategic placement of bonding patterns that create natural fold lines every 15-20 cm, reducing bending stress on the barrier layer during storage. The overall stiffness may be controlled to achieve bending modulus values within 20% of conventional terry cloth towels, ensuring familiar draping and handling properties during use.

### A. Outer Layers

In embodiments, the impermeable towel apparatus 100 may include a first outer layer 110 and a second outer layer 130. The outer layers 110, 130 may be sized and shaped substantially identically, allowing the towel apparatus 100 to lie substantially flat when assembled. Each of the outer layers 110, 130 may be made of absorbent materials such as cotton, terry cloth, microfiber, or bamboo fiber. The outer layers 110, 130 may be designed to absorb liquids while providing a soft, comfortable texture against the skin.

The absorbent materials may be selected based on specific performance characteristics and fiber properties. Cotton materials may utilize combed cotton fibers with staple lengths between 25-35 mm, providing absorption rates of 200-400 ml/m² within 30 seconds. Terry cloth configurations may feature loop pile heights between 3-8 mm with loop density of 150-300 loops per square inch, achieving absorption capacities up to 500% of the fabric weight. Microfiber materials may comprise polyester and polyamide blends with fiber diameters below 1 denier, creating capillary action through fiber spacing of 0.1-10 micrometers. The absorbent layers may have basis weights between 200-600 g/m², with higher weights providing increased absorption capacity while maintaining reasonable thickness and flexibility for the overall apparatus construction.

In some embodiments, the first outer layer 110 and the second outer layer 130 may have different textures and/or may be formed from materials. For example, the first outer layer 110 may comprise a softer, more plush material like terry cloth for comfortable use against the skin, while the second outer layer 130 may comprise a more durable material like microfiber for enhanced cleaning or scrubbing capabilities. This dual-texture and/or dual-material design may allow the apparatus 100 to serve multiple purposes depending on which side is used.

As another example, the first absorbent outer layer 110 may have a plush, velvety texture, while the second absorbent outer layer 130 may have a more textured, looped surface. These different textures may be achieved through various manufacturing processes. The plush, velvety texture of the first absorbent layer 110 may be created by using a microfiber material with very fine, densely packed fibers. This material may be woven or knitted to create a smooth, soft surface. The manufacturing process may involve splitting the fibers to increase their surface area and absorbency. This texture may be particularly suitable for gentle skin contact and may be preferred for applications such as facial towels or baby care. The more textured, looped surface of the second absorbent layer may be achieved through a terry weaving process. In this process, extra yarn may be woven into the base fabric to create small loops on the surface. These loops may increase the surface area of the fabric, enhancing its absorbency. The size and/or density of the loops may be varied to create different levels of texture. This textured surface may be particularly effective for applications requiring higher absorbency or a slight exfoliating effect, such as body towels or kitchen use.

The different textures on the absorbent layers 110, 130 may serve multiple purposes. The plush, velvety texture may provide a luxurious feel and gentle touch, making it suitable for sensitive skin or delicate surfaces. The looped texture may offer enhanced liquid absorption and may be more effective at trapping and holding moisture.

By incorporating these different textures, the impermeable towel apparatus 100 may offer versatility in its use. Users may choose which side to use based on their specific needs, whether it be for gentle cleansing, vigorous drying, or maximum absorption. The combination of textures may also contribute to the overall aesthetic appeal and perceived quality of the product.

The manufacturing process may involve selection and treatment of materials to achieve the desired textures while maintaining the necessary bonding with the water-impermeable inner layer. Special attention may be given to ensuring that the texturing processes do not compromise the integrity of the bonding between the layers.

The outer layers 110, 130 may be available in various colors, patterns, or designs to suit different aesthetic preferences or functional needs. In some embodiments, the outer layers 110, 130 may be treated with additional agents such as (but not limited to) antimicrobial, odor-resistant, and/or stain-resistant compounds to enhance their protective properties.

The thickness of each outer layer 110, 130 may vary depending on the specific application and desired level of absorbency. In some embodiments, each outer layer 110, 130 may have a thickness between 1-5 mm, allowing for sufficient absorbency while maintaining a total apparatus thickness similar to that of a standard towel.

### B. An Inner Layer

In embodiments, the impermeable towel apparatus 100 may include an inner layer 120. The inner layer 120 may be formed from one or more water-impermeable materials. In embodiments, the inner layer 120 may be sized and shaped substantially identically to the outer layers 110, 130, allowing the towel apparatus 100 to lie substantially flat when assembled with the inner layer interposed between the outer layers.

The water-impermeable material(s) may be, as non-limiting examples, thermoplastic polyurethane (TPU), polyvinyl chloride (PVC), latex, polyurethane, silicone, and/or other suitable polymers that provide a barrier against liquid penetration. The inner layer 120 may have a thickness between 0.1-2 mm, allowing it to maintain its impermeability while contributing minimally to the overall thickness of the apparatus 100.

The selection of specific barrier materials may be based on performance requirements and application needs. Thermoplastic polyurethane (TPU) may have a Shore A hardness between 80-95, providing flexibility while maintaining barrier properties. TPU films may have thickness between 0.1-0.5 mm and water vapor transmission rates below 0.5 g/m²/24hr according to ASTM E96. Silicone rubber barriers may utilize platinum-catalyzed systems with durometer readings between 30-60 Shore A, offering temperature stability from -40°C to 200°C. Polyvinyl chloride (PVC) barriers may be plasticized to achieve flexibility, with plasticizer content between 20-40% by weight and tensile strength exceeding 10 MPa. Material selection may consider chemical compatibility with detergents, with silicone providing superior resistance to alkaline conditions while TPU offers better abrasion resistance.

The barrier materials may exhibit specific polymer characteristics that contribute to performance. Thermoplastic polyurethane may provide flexibility through its segmented block copolymer structure, with hard segments providing strength and soft segments enabling flexibility. The molecular weight distribution may be controlled to optimize processing characteristics while maintaining barrier properties. Absorbent layer fibers may feature specific surface treatments to enhance wicking properties and liquid retention. Chemical compatibility matrices may guide material selection for exposure to various liquids, detergents, and environmental conditions. Degradation prevention may include UV stabilizers, antioxidants, and hydrolysis inhibitors to extend service life under various storage and use conditions.

In some embodiments, the inner layer 120 may be heat-resistant and/or chemical-resistant. This resistance may allow the impermeable towel apparatus 100 to withstand machine washing, machine drying, and/or dry cleaning processes without degradation of the water-impermeable properties. The heat resistance may be particularly important for maintaining the integrity of the inner layer 120 during high-temperature drying cycles.

The inner layer 120 may be highly resistant to heat, allowing the towel 100 to withstand elevated temperatures without degradation. The heat-resistant properties of the inner layer 120 may enable the towel 100 to maintain its impermeability and structural integrity during machine washing and drying cycles.

As one specific example, the inner layer 120 may be capable of withstanding temperatures up to 200°C (392°F) without melting, deforming, or losing water-impermeable properties. This temperature range may allow the towel 100 to be safely machine washed in hot water settings and tumble dried on high heat.

The heat resistance of the inner layer 120 may also permit the towel 100 to be used in applications involving exposure to warm or hot liquids. For example, the towel 100 may be suitable for use as a protective barrier when handling hot dishes or cookware in kitchen environments.

Additionally, the heat-resistant inner layer 120 may allow the impermeable towel 100 to be sterilized using autoclave processes in medical or laboratory settings. The inner layer 120 may maintain its impermeability and overall functionality when exposed to autoclave temperatures of 121°C (250°F) for standard sterilization cycles.

The inner layer 120 may be bonded to both the first outer layer 110 and the second outer layer 130 across substantially the entire surface area of the apparatus 100. For example, the first outer layer 110 may be bonded to a first side 120a of the inner layer 120 across substantially the entire surface area of the first side, and the second outer layer 130 may be bonded to a second side 120b of the inner layer across substantially the entire surface area of the second side. This bonding may be achieved through various methods such as (but not limited to) heat sealing, adhesive bonding, ultrasonic welding, or other textile bonding techniques. The comprehensive bonding may help prevent delamination or separation of the layers during use and/or cleaning processes.

In some embodiments, the inner layer 120 may optionally be treated with additional compounds to enhance its functionality. For example, the inner layer 120 may be infused with antimicrobial agents to prevent the growth of bacteria or fungi within the apparatus 100. This treatment may be particularly beneficial in applications where hygiene is a primary concern, such as in healthcare settings or for personal care use.

The inner layer 120 may be designed with specific surface characteristics to enhance its bonding with the outer layers 110, 130. For instance, the surface of the inner layer 120 may be textured or microporous to increase the surface area for bonding and improve adhesion to the absorbent outer layers.

Alternative embodiments may include partial barrier layer configurations where the water-impermeable inner layer 120 covers only selected regions of the apparatus, allowing controlled liquid transfer in designated areas. Multiple barrier layer arrangements may provide graduated protection levels, with two or more barrier layers separated by additional absorbent material. The apparatus may feature graduated thickness variations, with thicker absorbent regions in high-use areas and thinner sections for improved flexibility. Modular configurations may allow detachable layer systems where individual layers can be separated for cleaning or replacement, connected through removable fastening mechanisms such as snaps, zippers, or hook-and-loop closures.

### C. Reinforced Edge Portions

In embodiments, the impermeable towel apparatus 100 may include reinforced edge portions 140. The reinforced edge portions 140 may be incorporated along the perimeter of the impermeable towel apparatus 100. These edge portions 140 may be designed to provide additional durability and structural integrity to the multi-layer construction. The reinforced edge portions 140 may be formed by folding and/or stitching the outer layers 110, 130 around the inner layer 120 at the peripheral edges of the towel. This folding and/or stitching process may create a sealed edge that may help to prevent delamination or separation of the layers 110, 120, 130.

The reinforced edge portions 140 may be constructed using a variety of techniques. In one embodiment, the edge portions 140 may be reinforced with additional stitching patterns, such as double or triple stitching. This enhanced stitching may provide extra strength to the edges, potentially reducing wear and tear from frequent use and washing.

Additionally or alternatively, the reinforced edge portions 140 may incorporate a binding material. This binding material may be a strip of durable fabric or synthetic material that may be sewn around the perimeter of the towel. The binding material may be selected for its strength and resistance to fraying, potentially further enhancing the longevity of the towel edges.

The reinforced edge portions 140 may also be designed to maintain the water-impermeable properties of the towel at its edges. This may be achieved by extending the inner water-impermeable layer 120 to the very edge of the towel 100 before it is enclosed by the outer layers 110, 130. This configuration may help reduce or prevent any potential liquid penetration through the edges of the towel.

In some embodiments, the reinforced edge portions 140 may be constructed with a slightly thicker profile than the main body of the towel 100. This thicker edge may provide additional structural support and may potentially improve the towel's ability to maintain shape over time.

The material used for the reinforced edge portions 140 may be selected for its durability and compatibility with the rest of the towel construction. In some cases, a more robust version of the outer layer material may be used. Alternatively, a different material with superior wear resistance properties may be employed for the edge portions.

### D. An Attachment Mechanism

In some embodiments, the impermeable towel apparatus 100 may optionally include one or more attachment mechanisms 150. These attachment mechanisms 150 may be configured to secure the towel to various objects or surfaces.

In some embodiments, the attachment mechanisms 150 may comprise hook-and-loop fasteners. The hook portion may be attached to one side of the towel, while the loop portion may be attachable to a desired surface and/or another side of the towel. This configuration may allow the towel to be easily attached and detached as needed.

Alternatively, the attachment mechanisms 150 may include snap fasteners. These snap fasteners may be positioned along the edges of the towel. Corresponding snap components may be attached to surfaces where the towel is intended to be used, and/or to other portions of the towel.

In other embodiments, the attachment mechanisms 150 may comprise elastic and/or fabric straps or loops. These straps or loops may be sewn or otherwise attached to the corners or peripheral edges of the towel. The straps or loops may be positioned around objects (e.g., towel hooks) to secure the towel 100 in place.

In some configurations, the attachment mechanisms 150 may be in the form of grommets. These grommets may be installed adjacent to the peripheral edges of the towel 100, allowing the towel to be hung or tied to various objects using cords or hooks.

The placement and/or number of attachment mechanisms 150 may vary depending on the intended use of the towel. For example, a towel designed for use as a furniture cover may have attachment mechanisms 150 positioned at each corner, while a towel intended for personal use may have fewer (e.g., as few as zero) attachment points.

Proper maintenance may extend the service life and performance of the apparatus 100. Washing instructions may include machine washing in warm water up to 60°C using standard laundry detergents, while avoiding bleach or fabric softeners that may compromise barrier layer integrity. Drying may be accomplished through machine drying on medium heat settings or air drying, with temperatures not exceeding 80°C to prevent barrier layer degradation. Storage best practices may include ensuring complete drying before storage to prevent mold or mildew, and folding along natural crease lines to minimize stress on bonded areas. Troubleshooting may address common issues such as reduced absorption capacity, which may indicate the need for deep cleaning or replacement of heavily used units.

Storage and handling specifications may preserve apparatus integrity and performance throughout the product lifecycle. Storage environmental conditions may maintain temperatures between 5-35°C with relative humidity levels of 30-70% to prevent mold growth and material degradation. Packaging may utilize moisture barrier films with water vapor transmission rates below 0.1 g/m²/24hr to maintain material properties during extended storage periods up to 3 years. Folding procedures for storage may follow manufacturer-specified fold lines to minimize stress concentration on bonded areas, with fold radii not less than 10 mm to prevent barrier layer cracking. Stacking limitations may restrict vertical loading to maximum 50 units to prevent compression damage to lower units in storage. Handling procedures may specify lifting techniques for large units using multiple contact points spaced no more than 1 meter apart to prevent excessive stress on any single bonded area. Chemical storage compatibility may require separation from strong oxidizers, acids with pH below 3, and organic solvents to prevent material degradation during warehouse storage.

Maintenance procedures may be specified to ensure optimal performance and extended service life of the apparatus. Washing protocols may include pre-treatment for heavily soiled units using enzyme-based detergents at concentrations of 1-2% by weight in water temperatures of 40-50°C for 15-30 minutes before machine washing. Machine washing may utilize water temperatures not exceeding 60°C with pH-neutral detergents having pH values between 6.5-8.5 to prevent barrier layer degradation. Rinse cycles may include double rinsing to remove detergent residues that could affect absorption properties. Drying specifications may limit air temperatures to maximum 80°C with humidity levels below 60% to prevent condensation-related issues. Troubleshooting procedures may include absorption capacity testing using standardized volumes of water (100 ml per 100 cm²) with absorption times exceeding 60 seconds indicating need for deep cleaning or replacement. Visual inspection criteria may identify barrier layer compromise through dye penetration testing using food coloring solutions.

The apparatus 100 may be manufactured in various standard sizes to accommodate different applications. Hand towel configurations may measure approximately 40 cm × 60 cm, suitable for personal hygiene and small spill management. Bath towel sizes may range from 70 cm × 140 cm to provide full-body coverage for bathing applications. Beach towel dimensions may extend to 90 cm × 180 cm for recreational use and larger surface protection. Custom sizing capabilities may accommodate specialized applications, with manufacturing processes adaptable to dimensions ranging from 20 cm × 20 cm for compact applications up to 200 cm × 300 cm for large-scale coverage. Shape optimization may include rectangular, square, and contoured configurations designed for specific use cases, with packaging options including individual units, multi-packs, and/or bulk commercial quantities.

Size and configuration specifications may be achieved through precision manufacturing processes that maintain dimensional accuracy and consistency. Standard dimensions may be maintained within ±2% tolerance through controlled cutting and bonding processes, with edge finishing techniques that prevent fraying and maintain specified dimensions throughout the product lifecycle. Custom sizing capabilities may accommodate dimensions from minimum 15 cm × 15 cm up to maximum 250 cm × 200 cm, limited by manufacturing equipment width and material handling capabilities. Aspect ratio optimization may consider the relationship between length and width to maintain structural integrity, with length-to-width ratios typically not exceeding 4:1 to prevent excessive stress concentration during use. Corner radius specifications may range from 5-25 mm depending on overall size, providing durability while maintaining aesthetic appeal. Thickness uniformity across different sizes may be maintained through proportional adjustment of layer thicknesses, ensuring consistent performance characteristics regardless of overall dimensions.

### III. PLATFORM OPERATION

The methods described herein may be performed by one or more actors in various sequences. The stages of the methods may be re-arranged, combined, or separated into sub-stages without departing from the scope of the present disclosure. One or more actors may perform all stages of a method, or the stages may be distributed among multiple actors. The methods may be performed in conjunction with other methods, and portions of one method may be incorporated into another method.

The order of the stages in the methods may be varied. Certain stages may be performed concurrently or in parallel. Stages may be added, omitted, or modified without departing from the scope of the disclosure. The methods may be adapted to different operating environments and use cases.

The methods may be performed manually, automatically, or semi-automatically. Human intervention may be required at certain stages, while other stages may be fully automated. The methods may incorporate feedback loops, iterative processes, or conditional branching based on intermediate results.

The methods may be scaled to accommodate different production volumes, apparatus sizes, or application requirements. The methods may be optimized for efficiency, quality, cost, or other performance metrics. The methods may incorporate quality control checkpoints, error detection, and corrective actions.

The methods may be performed using standard equipment, specialized apparatus, or custom-designed systems. The methods may be adapted to work with different materials, layer configurations, or bonding techniques. The methods may be modified to accommodate different regulatory requirements, industry standards, or customer specifications.

### A. Method of Using an Impermeable Towel Apparatus

Consistent with embodiments of the present disclosure, a method may be performed by at least one of the aforementioned components. A method of using an impermeable towel apparatus that demonstrates the unique functional capabilities of the invention. The method begins with providing the three-layer towel structure (first absorbent layer, second absorbent layer, and water-impermeable barrier layer between them). The core steps involve contacting a liquid with the first surface of the first absorbent layer, allowing that layer to absorb the liquid, while the water-impermeable barrier layer prevents any penetration through to the second absorbent layer. This ensures the second absorbent layer remains substantially dry during the absorption process on the first side. This method captures the unique technical effect of absorbing liquids on one side of a towel apparatus while keeping the opposite side dry and available for use.

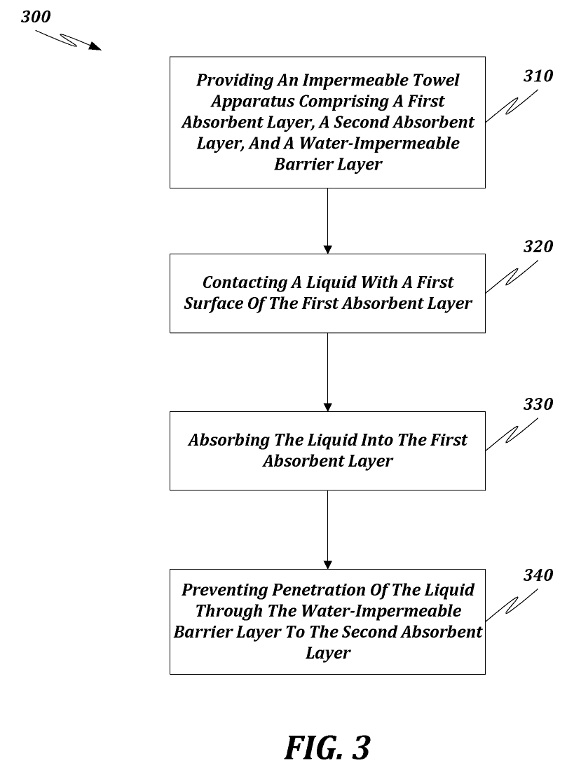

FIG. 3 is a flow chart setting forth the general stages involved in a method 300 consistent with an embodiment of the disclosure for using an impermeable towel apparatus. The method 300 may begin at stage 310 with providing an impermeable towel apparatus comprising a first absorbent layer, a second absorbent layer, and a water-impermeable barrier layer disposed therebetween. The apparatus may be positioned such that the first absorbent layer faces a potential liquid source. The second absorbent layer may be positioned against a surface requiring protection.

In stage 320, a user may contact a liquid using a first surface of the first absorbent layer. The liquid may be water, bodily fluids, spills, or other moisture sources. The first absorbent layer may receive the liquid through direct contact. The liquid may spread across the surface of the first absorbent layer upon contact.

In stage 330, the first absorbent layer may absorb the liquid into its fiber structure. Capillary action may draw the liquid into the interstitial spaces between fibers. The liquid may be distributed throughout the thickness of the first absorbent layer. The absorption may occur rapidly upon contact with the liquid.

In stage 340, the water-impermeable barrier layer may prevent penetration of the liquid through to the second absorbent layer. The barrier layer may block liquid transmission regardless of the saturation level of the first absorbent layer. The barrier layer may maintain its impermeability throughout the absorption process. The barrier layer may create a complete seal between the first absorbent layer and the second absorbent layer.

The second absorbent layer may remain substantially dry during absorption by the first absorbent layer. The second absorbent layer may maintain its dry state even when the first absorbent layer reaches full saturation. The protected surface beneath the second absorbent layer may remain completely dry. No moisture transfer may occur from the first absorbent layer to the second absorbent layer.

The method 300 may include removing the impermeable towel apparatus after use. The apparatus may be lifted from the protected surface. The first absorbent layer may contain the absorbed liquid within its structure. The apparatus may be transported to a washing location while maintaining liquid containment. In some embodiments, the towel apparatus may be rotated, folded, and/or otherwise manipulated such that the water-impermeable barrier layer substantially surrounds the first absorbent layer, helping to contain the absorbed liquid and prevent drips or leaks from the towel apparatus.

In some embodiments, the method 300 may comprise laundering the apparatus after use. The apparatus may be placed in a washing machine. The apparatus may undergo a wash cycle to remove absorbed liquids and contaminants. The apparatus may be dried in a dryer or by air drying. The apparatus may maintain its structural integrity and functional properties after laundering.

The method 300 may include reusing the apparatus after cleaning. The apparatus may be positioned for another use cycle. The first absorbent layer may regain its full absorption capacity after drying. The water-impermeable barrier layer may maintain its impermeability through multiple use cycles.

In some embodiments, the method 300 may comprise selecting an appropriate size of apparatus for the intended application. A user may choose a hand towel size for personal care applications. A user may select a bath towel size for furniture protection. A user may choose a larger size for bedding protection applications.

The method 300 may include positioning the apparatus with a specific outer layer facing upward. A user may select the first absorbent layer based on its texture. A user may choose a plush surface for skin contact applications. A user may select a textured surface for enhanced absorption or cleaning applications.

In some embodiments, the method 300 may comprise securing the apparatus using attachment mechanisms. The apparatus may include hook-and-loop fasteners along its edges. A user may engage the fasteners to secure the apparatus to furniture or bedding. The attachment mechanisms may prevent the apparatus from shifting during use.

The method 300 may include using the apparatus in a healthcare setting. A nursing mother may position the apparatus inside clothing to absorb breast milk leakage. The first absorbent layer may absorb the milk while the water-impermeable barrier layer prevents penetration to clothing. The mother may replace the apparatus when it becomes saturated.

In some embodiments, the method 300 may comprise using the apparatus for pet care. A pet owner may place the apparatus on flooring during house training. The first absorbent layer may absorb pet urine while the water-impermeable barrier layer protects the floor. The owner may remove and launder the apparatus after an accident occurs.

The method 300 may include using the apparatus for outdoor recreation. A user may place the apparatus on sand or grass at a beach or park. The second absorbent layer may contact the ground while the water-impermeable barrier layer prevents ground moisture from reaching the user. The first absorbent layer may face upward to provide a dry sitting or lying surface.

In some embodiments, the method 300 may comprise using the apparatus for furniture protection. A user may drape the apparatus over a sofa or chair. The second absorbent layer may contact the furniture surface. The first absorbent layer may face upward to absorb spills or pet accidents. The water-impermeable barrier layer may prevent liquid from reaching the furniture upholstery.

The method 300 may include using the apparatus for bedding protection. A user may position the apparatus on a mattress beneath bed sheets. The second absorbent layer may contact the mattress surface. The water-impermeable barrier layer may prevent moisture from reaching the mattress. The first absorbent layer may absorb perspiration or other bodily fluids during sleep.

In some embodiments, the method 300 may comprise monitoring the saturation level of the first absorbent layer. A user may observe the wetness of the first absorbent layer during use. The user may determine when the apparatus approaches its absorption capacity. The user may replace the apparatus with a dry one before saturation is reached.

The method 300 may include storing the apparatus when not in use. The apparatus may be folded for compact storage. The apparatus may be placed in a linen closet or storage area. The apparatus may maintain its shape and functional properties during storage.

In some embodiments, the method 300 may comprise treating the apparatus with additional agents. The apparatus may be treated with antimicrobial agents to inhibit bacterial growth. The apparatus may be treated with odor-resistant agents to prevent odor development. The apparatus may be treated with stain-resistant agents to facilitate cleaning.

The method 300 may include inspecting the apparatus for damage after repeated use. A user may examine the edges for signs of delamination. A user may check the water-impermeable barrier layer for tears or punctures. A user may verify that the bonding between layers remains intact.

The method 300 may include using the apparatus in combination with other protective measures. The apparatus may be used beneath additional bedding or furniture covers. The apparatus may be used in conjunction with waterproof mattress protectors. The apparatus may provide an additional layer of protection in high-risk scenarios.

### B. Method of Manufacturing an Impermeable Towel Apparatus

Consistent with embodiments of the present disclosure, a method may be performed to manufacture at least one of the aforementioned components. The impermeable towel apparatus may be manufactured using a multi-step bonding process that ensures structural integrity and durability. The manufacturing method may include providing first and second absorbent layers and positioning a water-impermeable barrier layer between them. The layers may be bonded across substantially the entire surface area using various bonding techniques, including heat welding, ultrasonic welding, adhesive bonding, or stitching. A reinforced perimeter edge may be formed to prevent delamination of the layers during use and washing.

The bonding process may create a substantially uniform bond strength across the entire surface area, ensuring consistent performance throughout the towel apparatus. In specific implementations, the bonding process may comprise applying heat and pressure simultaneously across the entire surface area at temperatures between 120°C and 180°C for durations of 10 to 60 seconds. This controlled thermal bonding may create a permanent laminated structure that maintains flexibility and durability through repeated washing cycles, allowing the apparatus to withstand standard laundering processes without degradation of the water-impermeable barrier layer or separation of the bonded layers.

The substantially uniform bond strength may be achieved and verified through specific manufacturing controls and testing procedures. Bond strength uniformity may be defined as variation not exceeding ±15% from the mean bond strength across the entire bonded area. Testing may be performed using T-peel tests according to ASTM D1876 at sample locations distributed across the surface in a grid pattern with sampling points every 10 cm. The minimum acceptable bond strength may be 5 N/cm width, with individual measurements ranging between 4.25-5.75 N/cm to meet uniformity criteria. Process control during manufacturing may include real-time monitoring of bonding temperature, pressure, and dwell time, with feedback systems maintaining parameters within ±2% of target values to ensure consistent bond formation across the entire production run.

The manufacturing process parameters may be optimized for different material combinations and production scales. For heat and pressure bonding at 120-180°C, the pressure application may range from 100-300 PSI distributed uniformly across heated platens or roller systems. The 10-60 second duration may be adjusted based on material thickness and thermal conductivity, with thicker assemblies requiring longer exposure times. Temperature control may be maintained within ±5°C through PID controllers and multiple temperature sensors across the bonding surface. Cooling phases may follow bonding, with controlled cooling rates of 2-5°C per second to prevent thermal stress and ensure dimensional stability. Quality monitoring may include real-time bond strength testing through pull-test sampling at regular intervals during production runs.

The manufacturing process may include precise environmental controls to ensure optimal bonding quality. The production environment may maintain humidity levels between 40-60% and ambient temperatures between 20-25°C. Quality control testing may include liquid penetration tests using standardized volumes of water applied at specific pressures to verify barrier integrity. Production line automation may employ continuous web processing with inline inspection systems that monitor bond strength using ultrasonic testing. The bonding pressure may range from 50-200 PSI depending on the specific materials used, with pressure distribution maintained uniformly across the entire surface area through precision roller systems or heated platens.

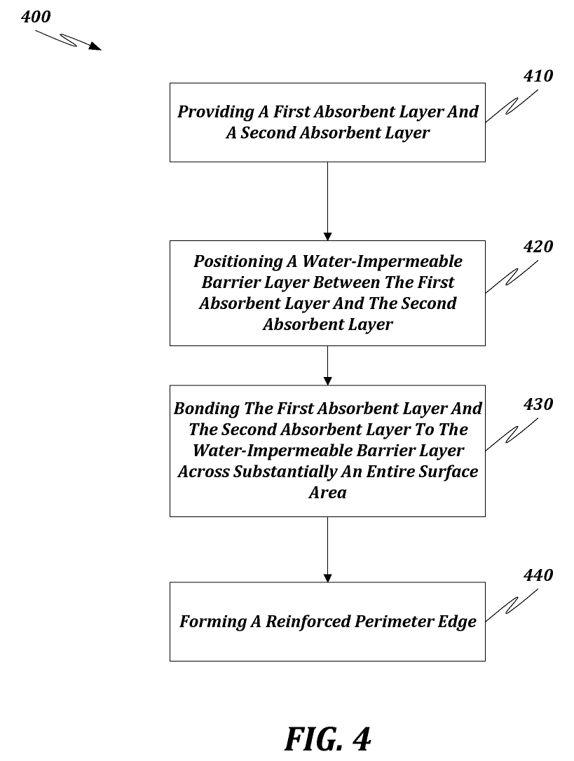

FIG. 4 is a flow chart setting forth the general stages involved in a method 400 consistent with an embodiment of the disclosure for using an impermeable towel apparatus. The method 400 may begin at stage 410 with providing a first absorbent layer and a second absorbent layer. Each layer may be selected from materials comprising cotton, terry cloth, microfiber, or bamboo fiber, and may have a thickness between 1 mm and 5 mm. The first absorbent layer may be provided in a predetermined shape and size; and the second absorbent layer may be provided in a shape and size substantially identical to the first absorbent layer. The first and second absorbent layers may be inspected for defects.

In stage 420, a water-impermeable barrier layer may be positioned between the first absorbent layer and the second absorbent layer. The water-impermeable barrier layer may comprise materials such as (but not limited to) polyvinyl chloride, latex, polyurethane, silicone, and/or the like. The water-impermeable barrier layer may have a thickness between 0.1 mm and 2 mm. The water-impermeable barrier layer may be sized to match the dimensions of the first absorbent layer and the second absorbent layer. The water-impermeable barrier layer may be aligned with the first absorbent layer and the second absorbent layer. The alignment may be verified using optical and/or mechanical alignment systems.

In stage 430, the first absorbent layer and the second absorbent layer may be bonded to the water-impermeable barrier layer across substantially an entire surface area. The bonding may be performed using one or more of heat welding, ultrasonic welding, adhesive bonding, and/or stitching. The bonding process may create a substantially uniform bond strength across the entire surface area. The bond strength may exceed 5 N/cm peel strength. The bonding may prevent delamination or separation of the layers during use.

For heat welding, the bonding process may comprise applying heat to the layers. The heat may be applied at a temperature between 120°C and 180°C. The heat may be applied for a duration between 10 seconds and 60 seconds. Pressure may be applied simultaneously with the heat. The pressure may be between 0.5 MPa and 2 MPa. The heat and pressure may cause the water-impermeable barrier layer to partially melt. The melted material may adhere to the first absorbent layer. The melted material may adhere to the second absorbent layer. The bonded layers may be cooled in a controlled manner. The cooling may prevent thermal distortion. The cooling may prevent warping of the apparatus.

For ultrasonic welding, the bonding process may comprise applying ultrasonic vibrations to the layers. The ultrasonic vibrations may have a frequency between 20 kHz and 40 kHz. The ultrasonic vibrations may cause frictional heating at the interface between layers. The frictional heating may cause localized melting. The localized melting may create fusion between the layers. The ultrasonic welding may be performed in a point pattern. The ultrasonic welding may be performed in a line pattern. The ultrasonic welding may be performed across the entire surface area.

For adhesive bonding, the bonding process may comprise applying an adhesive to the water-impermeable barrier layer. The adhesive may be a polyurethane adhesive, an acrylic adhesive, a hot-melt adhesive, and/or the like. The adhesive may be applied using various methods, such as (but not limited to) a spray method, a roller method, and/or a slot-die coating method. The adhesive may be applied in a continuous film or a patterned application. The first absorbent layer may be pressed against the adhesive-coated surface. The second absorbent layer may be pressed against the opposite adhesive-coated surface. Pressure may be applied using rollers. In various embodiments, the adhesive may be cured (e.g., using heat, ultraviolet light, moisture exposure, etc.).

For stitching, the bonding process may comprise sewing the layers together. The stitching may use polyester thread, nylon thread, and/or other threads compatible with the materials. The stitching may be performed in various patterns (e.g., a grid pattern, parallel lines, etc.). The stitch density may be between 3 and 5 stitches per centimeter. The stitching may penetrate through all three layers. Seam sealing tape may be applied over the stitching lines to maintain the water-impermeable properties at the stitched locations.

Alternative bonding methods may be selected based on material compatibility and production requirements. Ultrasonic welding may utilize frequencies between 20-40 kHz with amplitude settings of 10-50 micrometers, applied for durations of 0.1-2.0 seconds per weld point. The ultrasonic energy may create localized heating to 150-200°C, sufficient to bond thermoplastic materials without affecting surrounding areas. Adhesive bonding may employ water-based polyurethane adhesives applied at coverage rates of 50-150 g/m², with open times of 2-10 minutes before layer assembly. Curing may occur at ambient temperature over 24-48 hours or accelerated at 60°C for 2-4 hours. Stitching methods may utilize lockstitch or overlock configurations with thread tensions between 50-150 grams, stitch densities of 8-16 stitches per inch, and needle sizes appropriate for the combined material thickness to prevent perforation damage to the barrier layer.

In stage 440, a reinforced perimeter edge may be formed to reduce or prevent delamination of the layers. The reinforced perimeter edge may be formed by folding the first or second absorbent layer around the edge of the water-impermeable barrier layer. Alternatively, the reinforced perimeter edge may be formed by attaching an edge material to wrap around the first absorbent layer, the water impermeable barrier layer, and the second absorbent ;layer at the peripheral edge of the towel apparatus. The water-impermeable barrier layer may extend to the very edge before being enclosed. The edges may be secured using stitching (e.g., a double stitch pattern, a triple stitch pattern, etc.). The stitch density may be between 3 and 5 stitches per centimeter.

A binding material may be applied to the perimeter edge. The binding material may be a polyester webbing., a cotton bias tape, a synthetic leather strip, and/or the like. The binding material may have a width between 10 mm and 25 mm. The binding material may be sewn around the entire perimeter to enclose all three layers. The binding material may help to prevent fraying of the absorbent layers and/or enhance the durability of the edge.

The reinforced perimeter edge may be heat sealed. Heat sealing may be performed at a temperature between 150°C and 200°C. Heat sealing may create a fused edge. The fused edge may help to prevent delamination and maintain the water-impermeable seal at the perimeter. The reinforced perimeter edge may have a thickness greater than the main body of the apparatus. The increased thickness may provide additional structural support and/or improve the apparatus's ability to maintain its shape.

The bonding process may create a permanent laminated structure. The laminated structure may maintain flexibility, allowing the apparatus to be folded and/or draped over surfaces in a manner similar to that of a traditional towel. The laminated structure may maintain durability through repeated washing cycles without degradation.

The bonding process may allow the apparatus to withstand standard laundering processes. For example, the apparatus may be machine washed at temperatures up to 60°C, or up to 90°C. The apparatus may be machine dried at temperatures up to 80°C, or up to 100°C. The water-impermeable barrier layer may maintain its impermeability after washing. The water-impermeable barrier layer may maintain its impermeability after drying. The bond between the layers may maintain its strength after washing. The bond between the layers may maintain its strength after drying.

The bonding process may prevent separation of the bonded layers during mechanical agitation. The apparatus may withstand the mechanical forces of a washing machine, the centrifugal forces of a spin cycle, and the tumbling action of a dryer. The layers may remain bonded during folding and unfolding. The layers may remain bonded during storage. The layers may remain bonded during use.

Quality control testing may be performed after the bonding process. The bond strength may be measured using peel tests. The peel strength may be measured at multiple locations across the surface. The peel strength may be required to exceed a minimum threshold. Samples may be subjected to accelerated aging tests. Samples may be subjected to repeated wash and dry cycles. The bond integrity may be verified after the accelerated aging tests. Defective units may be identified and removed from production.

The manufacturing method 400 may include additional optional stages. The first and/or second absorbent layer may be treated with antimicrobial agents before bonding. The first and/or second absorbent layer may be treated with odor-resistant agents. The first and/or second absorbent layer may be treated with stain-resistant agents.

The water-impermeable barrier layer may be treated with antimicrobial agents. The antimicrobial treatment may be applied to a first and/or surface of the water-impermeable barrier layer. The antimicrobial agents may comprise silver nanoparticles, quaternary ammonium compounds, zinc pyrithione, and/or the like.

The manufacturing method 400 may include cutting the bonded layers to a final size. The cutting may be performed using a die-cutting process, a laser-cutting process, an ultrasonic-cutting process, a blade-cutting process, and/or any other cutting process that creates clean edges. The cutting process may minimize fraying of the absorbent layers.

The manufacturing method 400 may include inspecting the finished apparatus. The inspection may verify the dimensional accuracy of the apparatus. The inspection may verify the bond integrity across the surface. The inspection may verify the water-impermeable properties of the barrier layer. The inspection may identify any defects in the materials. The inspection may identify any defects in the bonding. Defective units may be rejected. Acceptable units may be packaged for distribution.

The manufacturing method 400 may include folding the finished apparatus for packaging. The apparatus may be folded into a compact configuration. The folded apparatus may be placed in a plastic bag. The folded apparatus may be placed in a cardboard box. The folded apparatus may be wrapped in tissue paper. A label may be attached to the package.

The manufacturing method 400 may be performed in a continuous production line. The first absorbent layer may be fed from a first roll. The second absorbent layer may be fed from a second roll. The water-impermeable barrier layer may be fed from a third roll. The layers may be aligned using automated alignment systems. The bonding may be performed using automated bonding equipment. The cutting may be performed using automated cutting equipment. The inspection may be performed using automated inspection systems. The packaging may be performed using automated packaging equipment.

The manufacturing method 400 may be scaled to produce apparatus of different sizes. The method may be used to produce hand towel sizes, bath towel sizes, beach towel sizes, and/or any other desired sizes. The dimensions of the layers may be adjusted according to the desired final size. The bonding parameters may be adjusted according to the size of the apparatus.

The manufacturing method 400 may be adapted to produce apparatus with different material combinations. The first absorbent layer may be cotton in one production run. The first absorbent layer may be microfiber in another production run. The second absorbent layer may be terry cloth in one production run. The second absorbent layer may be bamboo fiber in another production run. The water-impermeable barrier layer may be polyvinyl chloride in one production run. The water-impermeable barrier layer may be polyurethane in another production run. The bonding parameters may be adjusted according to the specific materials used.

The manufacturing method 400 may include environmental controls. The production environment may be maintained at a controlled temperature and/or humidity level. The controlled environment may help to ensure consistent bonding quality, prevent contamination of the materials, and/or optimize or otherwise improve the curing of adhesives.

While the specification includes examples, the disclosure’s scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

1. An impermeable towel apparatus comprising:
a first absorbent layer;
a second absorbent layer; and
a water-impermeable barrier layer disposed between the first absorbent layer and the second absorbent layer;
wherein the first absorbent layer and the second absorbent layer are bonded to the water-impermeable barrier layer across substantially an entire surface area of the impermeable towel apparatus;
wherein the impermeable towel apparatus is configured to absorb liquids on both outer surfaces while preventing liquid penetration through the water-impermeable barrier layer.

2. The impermeable towel apparatus of claim 1, wherein:
the first absorbent layer and the second absorbent layer comprise a material selected from the group consisting of cotton, terry cloth, microfiber, and bamboo fiber.

3. The impermeable towel apparatus of claim 1, wherein:
the water-impermeable barrier layer comprises a material selected from the group consisting of polyvinyl chloride (PVC), latex, polyurethane, and silicone.

4. The impermeable towel apparatus of claim 1, wherein:
the impermeable towel apparatus has a total thickness between 2 mm and 10 mm.

5. The impermeable towel apparatus of claim 1, wherein:
the water-impermeable barrier layer is heat-resistant and chemical-resistant, allowing the impermeable towel apparatus to withstand machine washing, machine drying, and dry cleaning processes without degradation.

6. The impermeable towel apparatus of claim 1, further comprising:
a reinforced perimeter edge enclosing the first absorbent layer, the second absorbent layer, and the water-impermeable barrier layer;
wherein the reinforced perimeter edge is configured to prevent delamination of the layers.

7. The impermeable towel apparatus of claim 1, wherein:
the first absorbent layer and the second absorbent layer have different textures, providing different functionalities on each side of the impermeable towel apparatus.

8. The impermeable towel apparatus of claim 1, wherein:
the impermeable towel apparatus is configured in a shape selected from the group consisting of rectangular, circular, and contoured to fit a specific surface.

9. The impermeable towel apparatus of claim 1, further comprising:
at least one attachment mechanism disposed along an edge of the impermeable towel apparatus;
wherein the attachment mechanism is configured to secure the impermeable towel apparatus to an object or surface.

10. The impermeable towel apparatus of claim 1, wherein:
the impermeable towel apparatus is treated with at least one of an antimicrobial agent, an odor-resistant agent, and a stain-resistant agent.

11. The impermeable towel apparatus of claim 1, further comprising:
a system configuration wherein the impermeable towel apparatus is provided as part of a multi-component towel system.

12. The impermeable towel system of claim 11, wherein:
the first absorbent layer and the second absorbent layer comprise terry cloth material, and
the water-impermeable layer comprises a heat-resistant polymer.

13. The impermeable towel system of claim 11, wherein the multi-layer towel structure has a thickness within 20% of a thickness of a standard single-layer towel.

14. The impermeable towel system of claim 11, wherein the multi-layer towel structure is configured to withstand machine washing, machine drying, and dry cleaning processes without degradation of the water-impermeable layer.

15. The impermeable towel system of claim 11, further comprising:
a plurality of reinforced edge portions along a perimeter of the multi-layer towel structure,
wherein the plurality of reinforced edge portions are configured to prevent separation of the first absorbent layer, the second absorbent layer, and the water-impermeable layer.

16. A method of using an impermeable towel apparatus, the method comprising:
providing an impermeable towel apparatus comprising a first absorbent layer, a second absorbent layer, and a water-impermeable barrier layer disposed therebetween;
contacting a liquid with a first surface of the first absorbent layer;
absorbing the liquid into the first absorbent layer; and
preventing penetration of the liquid through the water-impermeable barrier layer to the second absorbent layer,
wherein the second absorbent layer remains substantially dry during absorption by the first absorbent layer.

17. The method of claim 16, further comprising:
simultaneously contacting a second liquid with a second surface of the second absorbent layer; and
absorbing the second liquid into the second absorbent layer while maintaining separation between the first liquid and the second liquid via the water-impermeable barrier layer.

18. A method of manufacturing an impermeable towel apparatus, the method comprising:
providing a first absorbent layer and a second absorbent layer;
positioning a water-impermeable barrier layer between the first absorbent layer and the second absorbent layer;
bonding the first absorbent layer and the second absorbent layer to the water-impermeable barrier layer across substantially an entire surface area using a bonding process selected from the group consisting of heat welding, ultrasonic welding, adhesive bonding, and stitching; and
forming a reinforced perimeter edge to prevent delamination of the layers.

19. The method of claim 18, wherein the bonding process creates a substantially uniform bond strength across the entire surface area of the impermeable towel apparatus.

20. The method of claim 18, wherein the bonding process comprises applying heat and pressure simultaneously across the entire surface area at a temperature between 120°C and 180°C for a duration of 10 to 60 seconds, creating a permanent laminated structure that maintains flexibility and durability through repeated washing cycles.
